(19) United States
(12) Patent Application Publication
(10) Pub. No.: US 2022/0253754 A1
(43) Pub. Date: Aug. 11, 2022

(54) ONLINE PARKING LOT RESERVATION METHOD AND DEVICE, AND COMPUTER-READABLE STORAGE MEDIUM

(71) Applicant: ParkingCloud Co., Ltd., Seoul (KR)

(72) Inventors: Sang Yong SHIN, Seoul (KR); Hwa Jin LEE, Seoul (KR); Eun Hoi GOO, Seoul (KR)

(73) Assignee: ParkingCloud Co., Ltd., Seoul (KR)

(21) Appl. No.: 17/625,455

(22) PCT Filed: Jun. 8, 2020
(86) PCT No.: PCT/KR20/07374

§ 371 Date: Jan. 7, 2022

(30) Foreign Application Priority Data
Jul. 8, 2019 (KR) 10-2019-0082298
Jan. 30, 2020 (KR) 10-2020-0011112

(51) Int. Cl. G06Q 10/02; G08G 1/14

(52) U.S. Cl. CPC G06Q 10/02; G08G 1/146; G08G 1/144

(57) ABSTRACT

A method performed by a system for providing a parking lot reservation service according to an embodiment of the present disclosure includes a process of receiving point of departure information and destination information from a user device, a process of identifying, based on the received destination information, real-time parking space information of each of at least one parking lot located within a reference distance from a location of the destination information, a process of determining at least one candidate parking lot from among the at least one parking lot, a process of transmitting the point of departure information and the destination information to a traffic information system and receiving an estimated time of arrival which has been calculated by the traffic information system based on the point of departure information and the destination information, a process of calculating, based on big data stored in a database, an estimated available parking space of each of the at least one candidate parking lot at the estimated time of arrival, and a process of transmitting, to the user device, information about the at least one candidate parking lot and the estimated available parking space of each candidate parking lot. Various other embodiments are also possible.

### TECHNICAL FIELD

The present disclosure relates to an online parking lot reservation method, device and a computer-readable storage medium. More specifically, the present disclosure relates to a method, device and computer-readable storage medium for online reservation for a parking lot around a destination, to which a user is headed, by using big data.

### BACKGROUND

Unless otherwise indicated herein, the materials described in this section are not prior art to the claims in this application and are not admitted as prior art by inclusion in this section. Compared to the increased number of cars, parking capacity is far from enough. Thus, even if a parking space is secured at the destination, users often experience problems with parking after arriving at the destination. Therefore, a technique for providing information about parking lots around the destination to users has been developed.

For example, Korean Patent No. 10-1248621 discloses a method by which destination information is received from a user's smart device, search for the received destination and parking lot around the destination are searched and real-time parking information of the searched parking lot is transmitted to the user's smart device to enable the user to check the location and real-time parking information of the parking lot. That is, an objective of this patent is to provide a high quality parking lot service to a user by transmitting parking lot information to the user's smart device in real time so that the user can check the current status of a parking lot around the destination and identify the location of the parking lot in advance before arriving at the destination, and can move efficiently to the destination after parking.

However, in this patent, it is not presumed that a plurality of parking lots exists around the destination, and even if parking lot information is provided in real time, it is not possible to prepare for the case where a parking lot does not have a parking space when the user arrives at the parking lot, and, thus, the user has to search for another parking lot.

Accordingly, there is a need for a service capable of providing a user with comprehensive guidance and reservation for a plurality of parking lots around the destination.

### DISCLOSURE OF THE INVENTION

The present disclosure is proposed to provide a user with a comprehensive guidance and reservation service for a plurality of parking lots around the destination, and a service providing cloud provides information about parking lots around a destination input from the user, and a parking lot recommendation system provides a list of parking lots scored based on a predetermined user preference.

In order to provide reliable parking lot information to users, an available parking space calculation system configured to grasp the number of estimated available parking spaces at the estimated time of arrival calculated from big data by using the estimated time of arrival calculated by a traffic information system and the real-time current status of a parking lot provided from the parking lot may be further applied to the present disclosure.

Also, a temporary reservation and reservation confirmation system based on a distance from the current parking lot and information about the current parking space through a navigation link may be further applied to the present disclosure.

Further, a notification message system for providing parking information to a user in real time may be further applied to the present disclosure.

The foregoing summary is illustrative only and is not intended to be in any way limiting. In addition to the illustrative embodiments and features described above, further embodiments and features will become apparent by reference to the drawings and the following detailed description.

A method performed by a computing device included in a system for providing a parking lot reservation service according to an embodiment of the present disclosure includes: a process of receiving point of departure information and destination information from a user device; a process of identifying, based on the received destination information, real-time parking space information of each of at least one parking lot located within a reference distance from a location of the destination information; a process of determining at least one candidate parking lot from among the at least one parking lot; a process of transmitting the point of departure information and the destination information to a traffic information system and receiving an estimated time of arrival which has been calculated by the traffic information system based on the point of departure information and the destination information; a process of calculating, based on big data stored in a database, an estimated available parking space of each of the at least one candidate parking lot at the estimated time of arrival; and a process of transmitting, to the user device, information about the at least one candidate parking lot and the estimated available parking space of each candidate parking lot. Various other embodiments are also possible.

According to an embodiment of the present disclosure, the method may further include: a process of calculating a score of the at least one candidate parking lot by using at least one of a distance from the estimated available parking space and the destination to the at least one candidate parking lot, a parking fee of the candidate parking lot, and the candidate parking lot; and a process of transmitting the calculated score to the user device. According to an embodiment of the present disclosure, the method may further include: a process of receiving the estimated time of arrival from the user device, and the estimated time of arrival may be received in response to a request from the user device to the traffic information system.

According to an embodiment of the present disclosure, the process of transmitting the point of departure information and the destination information to the traffic information system and receiving the estimated time of arrival which has been calculated by the traffic information system based on the point of departure information and the destination information includes a process of transmitting location information of each of the at least one candidate parking lot to the traffic information system, and the estimated time of arrival may indicate a time of arrival at each of the at least one candidate parking lot.

According to an embodiment of the present disclosure, the method may further include: a process of receiving, from the user device, information about a first parking lot selected by a user from among the at least one candidate parking lot and identifying a reservation from a vehicle associated with the user device for the first parking lot; a process of checking an available parking space of the first parking lot when it is confirmed that the vehicle for the user device has entered within a reference distance from a location of the first parking lot; and a process of identifying a reservation confirmation for the first parking lot when the available parking space of the first parking lot remains as a result of checking real-time parking information of the first parking lot, and transmitting information about the reservation.

According to an embodiment of the present disclosure, the method may further include a process of identifying a reservation cancellation for the first parking lot when the available parking space of the first parking lot does not remain as a result of checking the real-time parking information of the first parking lot, and transmitting, to the user device, a message informing the reservation cancellation.

According to an embodiment of the present disclosure, the method may further include: a process of checking whether the vehicle has entered the first parking lot within a reference time when the reservation confirmation for the first parking lot is identified; and a process of identifying a reservation cancellation for the first parking lot when it is confirmed that the vehicle has not entered the first parking lot within the reference time, and transmitting, to the first parking lot and the user device, a message informing the reservation cancellation.

According to an embodiment of the present disclosure, the method may further include a process of transmitting, to the user device, information about a second parking lot among the at least one candidate parking lot when the reservation cancellation for the first parking lot is identified.

According to an embodiment of the present disclosure, the method may further include a process of calculating a score of each of the at least one candidate parking lot based on a user preference stored in the database.

According to an embodiment of the present disclosure, the user preference may include at least one of a parking fee, a distance from the destination information, whether the parking lot is an automated parking lot (tower-type), whether the parking lot is equipped with an electric vehicle charging device, and discount components.

According to an embodiment of the present disclosure, a computer-readable storage medium stores a program for providing a parking lot reservation service, and the program includes at least one instruction that, when executed by a computing device, causes the computing device: to receive point of departure information and destination information from a user device; to identify, based on the received destination information, real-time parking space information of each of at least one parking lot located within a reference distance from a location of the destination information; to determine at least one candidate parking lot from among the at least one parking lot; to transmit the point of departure information and the destination information to a traffic information system and receive an estimated time of arrival which has been calculated by the traffic information system based on the point of departure information and the destination information; to calculate, based on big data stored in a database, an estimated available parking space of each of the at least one candidate parking lot at the estimated time of arrival; and to transmit, to the user device, information about the at least one candidate parking lot and the estimated available parking space of each candidate parking lot.

### BRIEF DESCRIPTION OF THE DRAWINGS

The foregoing and other features of the present disclosure will be described in detail with reference to the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1 is a conceptual diagram illustrating an online parking lot reservation system, in accordance with an embodiment;

FIG. 2 is a block diagram for describing a cloud network included in the parking lot reservation system of FIG. 1;

FIG. 3 is a flowchart for describing an operation process performed to provide a parking lot recommendation service by the parking lot reservation system, in accordance with an embodiment of the present disclosure;

FIG. 4 illustrates an example of an application executed on a user device, in accordance with an embodiment of the present disclosure;

FIG. 5 is a flowchart for describing an operation process performed to provide a parking lot reservation and cancellation service by the parking lot reservation system, in accordance with an embodiment of the present disclosure.

FIG. 6 to FIG. 9 illustrate examples of notification messages for providing information about a parking lot reservation to a user, in accordance with an embodiment of the present disclosure.

FIG. 10 is a flowchart for describing an operation process performed to provide a parking lot reservation and cancellation service by the parking lot reservation system, in accordance with another embodiment of the present disclosure; and

FIG. 11 illustrates an exemplary computer program product that can be used in entities included in the parking lot reservation system, in accordance at least some embodiments of the present disclosure.

### BEST MODE FOR CARRYING OUT THE INVENTION

The terms used herein are used only to describe specific examples, but do not intend to limit the present disclosure. A singular expression includes a plural expression unless it is clearly construed in a different way in the context. All terms including technical and scientific terms used herein have the same meaning as commonly understood by a person with ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. In some cases, even terms defined in the present disclosure should not be interpreted as excluding embodiments of the present disclosure.

The foregoing features and other features of the present disclosure will be sufficiently apparent from the following descriptions with reference to the accompanying drawings. These drawings merely illustrate several exemplary embodiments in accordance with the present disclosure. Therefore, they should not be understood as limiting the present disclosure. The present disclosure will be described in more detail with reference to the accompanying drawings.

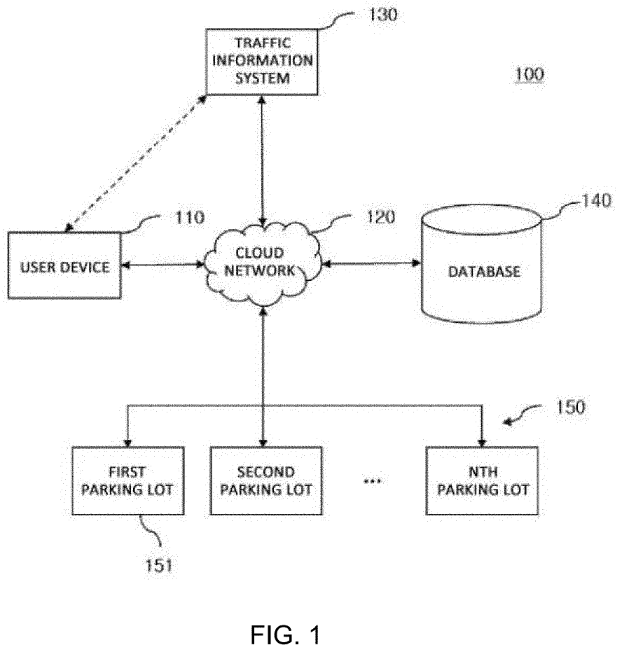

FIG. 1 is a conceptual diagram illustrating an online parking lot reservation system, in accordance with an embodiment.

Referring to FIG. 1, an online parking lot recommendation and reservation system 100 (hereinafter, referred to as “parking lot reservation system”) may include a user device 110, a cloud network 120, a traffic information system 130, a database 140 and a plurality of parking lots 150. As entities of parking lot reservation system 100, user device 110, traffic information system 130, database 140 and plurality of parking lots 150 may be communicatively connected through cloud network 120 and may transmit and receive information, data and messages through cloud network 120. Here, the term “communicative connection” refers to a connection structure that enables information exchange between nodes such as a plurality of devices and servers included in user device 110, cloud network 120, traffic information system 130, database 140 and plurality of parking lots 150 of parking lot reservation system 100. Examples of the network that enables such communicative connection may include an RF, a 3GPP (3rd Generation Partnership Project) network, an LTE (Long Term Evolution) network, a 5GPP (5th Generation Partnership Project) network, a WIMAX (World Interoperability for Microwave Access) network, the Internet, a LAN (Local Area Network), a Wireless LAN (Wireless Local Area Network), a WAN (Wide Area Network), a PAN (Personal Area Network), a Bluetooth network, an NFC network, a satellite broadcasting network, an analog broadcasting network, a DMB (Digital Multimedia Broadcasting) network, and the like, but are not limited thereto.

According to an embodiment, user device 110 may represent any computing device which is possessed by user who intends to reserve a parking lot and is capable of wireless communication. The user may request a parking lot reservation from parking lot reservation system 100 and receive a notification on the parking lot reservation status by using user device 110. User device 110 may include various types of computing devices. For example, user device 110 may include portable devices, such as a mobile phone, a smartphone, a PDA, a tablet PC and a laptop, or non-portable computing devices, such as a desktop and a server. Also, user device 110 may further include a navigation device installed in a vehicle in which the user is riding.

In user device 110, an application program that enables the user to reserve a parking lot and receive a notification through parking lot reservation system 100 may be installed. That is, parking lot reservation system 100 of the present disclosure can be implemented by the application program installed in user device 110. The user may execute the application program installed in user device 110 and use various convenient graphic user interfaces (GUI) to reserve a parking lot and receive a notification. Also, parking lot reservation system 100 of the present disclosure may be implemented by a web browser application executed on user device 110. Herein, the web browser refers to a program that allows web (world wide web: WWW) service to be used and receives and shows a hypertext described in HTML (hypertext mark-up language). For example, the web browser may include Netscape, Explorer, Chrome or the like.

According to an embodiment, cloud network 120 may be a service environment in which computing resources of hardware and software at different physical locations are integrated by virtualization technology in order for parking lot reservation system 100 to provide the user with a comprehensive guidance and reservation service for a plurality of parking lots around the destination. In other words, cloud network 120 may include at least one server, and the at least one server may be configured to perform operations to be performed by parking lot reservation system 100 to provide a parking lot reservation and reservation status notification service. Therefore, in the following description, cloud network 120 may refer to at least one server constituting cloud network 120 even if it is described in a singular form.

According to an embodiment, traffic information system 130 may represent an interface environment for providing traffic information that enables parking lot reservation system 100 to calculate an estimated time of arrival from an point of departure to a destination selected by the user. For example, traffic information system 130 may include an open API (open application programming interface) of a public institution such as the National Police Agency of the Ministry of Land, Infrastructure and Transport, which is equipped with a system for comprehensively assessing major road conditions and traffic volume in Korea, or an open API (e.g., T map navigation™) of a navigation service provided by a private institution such as a wireless operator.

According to an embodiment, database 140 may store information about a parking lot provided by parking lot reservation system 100. Database 140 may store basic information such as the total number of parking spaces and a fee charging system for each of plurality of parking lots 150. Database 140 may update real-time parking information such as the number of currently available parking spaces and reservation status of each of plurality of parking lots 150 in real time. Database 140 may further store information about a user preference to recommend a parking lot to the user. Also, database 140 may construct, as big data, a data set for the number of available parking spaces for each period for each of plurality of parking lots 150.

According to an embodiment, plurality of parking lots 150 may be parking lots affiliated to parking lot reservation system 100 and capable of providing a service of parking lot reservation system 100 to the user. Each of plurality of parking lots 150 may include at least one communication device to provide basic information about the parking lot and real-time parking information to parking lot reservation system 100. Each of plurality of parking lots 150 may also include at least one entry/exit device to assess real-time parking information and precise parking space information (parking lot occupancy information). A plurality of parking lots 150 may be targets for which the user (or user device 110) reserves a parking space through parking lot reservation system 100. Parking lot reservation system 100 may identify, for example, a first parking lot 151 as a reserved parking lot by the choice of the user.

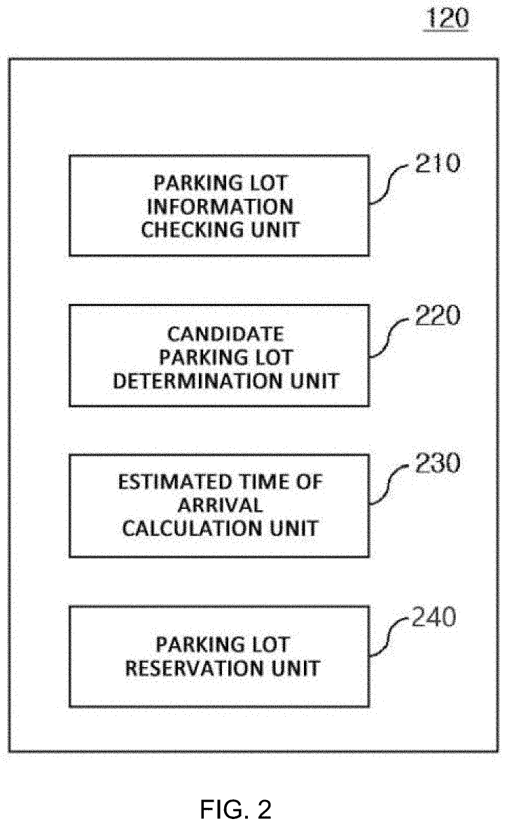

FIG. 2 is a block diagram for describing cloud network 120 included in parking lot reservation system 100 of FIG. 1. Referring to FIG. 2, cloud network 120 may include a parking lot information checking unit 210, a candidate parking lot determination unit 220, an estimated time of arrival calculation unit 230 and a parking lot reservation unit 240. Since cloud network 120 is composed of at least one server, parking lot information checking unit 210, candidate parking lot determination unit 220, estimated time of arrival calculation unit 230 and parking lot reservation unit 240 may be provided in a single server or distributed in a plurality of servers. Also, since all of these components may be included in each of a plurality of servers, cloud network 120 may include a plurality of at least one of these components. The operations of the respective components may be distributed and performed depending on, for example, available resources of the server.

According to an embodiment of the present disclosure, parking lot information checking unit 210 may be configured to check and manage basic information and real-time parking information of each of plurality of parking lots 150 affiliated to parking lot reservation system 100. The basic information may include the location of each of plurality of parking lots 150, the type of parking lot (underground parking lot, road parking lot, elevator type automated parking lot, etc.), the number of parking spaces, a fee charging system, and discount components. The real-time parking information may include the number of currently available parking spaces (the number of remaining parking spaces) and the reservation status. The basic information may be stored and managed in database 140. The real-time parking information may be regularly received from each of plurality of parking lots 150 and updated, or real-time parking information provided by each of plurality of parking lots 150 in response to a request from parking lot reservation system 100 (or parking lot information checking unit 210) may be received and updated. Parking lot information checking unit 210 may provide information about each of plurality of parking lots 150 required to perform a parking lot recommendation service, a parking lot reservation and confirmation service and a parking lot reservation notification message service provided by parking lot reservation system 100.

According to an embodiment of the present disclosure, candidate parking lot determination unit 220 may determine an available parking lot around the destination from among plurality of parking lots 150 in order to recommend a candidate parking lot to the user (or user device 110). Candidate parking lot determination unit 220 may identify, as a candidate parking lot, a parking lot located within a reference distance from the destination among plurality of parking lots 150 based on the destination information received from user device 110. Candidate parking lot determination unit 220 may identify a currently available parking space (hereinafter, referred to as “currently available parking space”) of the identified candidate parking lot based on the real-time parking information. Candidate parking lot determination unit 220 may identify an available parking space (hereinafter, referred to as “estimated available parking space”) for an estimated time of arrival at the candidate parking lot calculated based on the big data and an estimated time of arrival at the destination. Candidate parking lot determination unit 220 may determine a score of each candidate parking lot based on the currently available parking space, the estimated available parking space, the distance between the destination and each candidate parking lot and the user preference. Candidate parking lot determination unit 220 may transmit, to user device 110, data including candidate parking lots and scores of the respective candidate parking lots.

According to an embodiment of the present disclosure, estimated time of arrival calculation unit 230 may calculate an estimated time of arrival from an point of departure to a destination selected by the user. Estimated time of arrival calculation unit 230 may receive destination information and point of departure information (e.g., a current location of the user (or user device 110)) from user device 110. In some embodiments, estimated time of arrival calculation unit 230 may further receive an estimated time of departure (e.g., current time or specific time input by the user) from user device 110. Estimated time of arrival calculation unit 230 may calculate an estimated time of arrival by using traffic information system 130. Estimated time of arrival calculation unit 230 may transmit the received destination information and point of departure information to traffic information system 130 and receive an estimated time of arrival from traffic information system 130. Traffic information system 130 may, for example, search for a route from an point of departure to a destination and calculate an estimated time of arrival depending on traffic information.

In some embodiments, traffic information system 130 may check traffic conditions on the route from the point of departure to the destination at the estimated time of departure based on the big data and reflect the traffic conditions to calculate an estimated time of arrival based on the estimated time of departure. In another embodiment, the estimated time of arrival may be received directly from user device 110. User device 110 may obtain the estimated time of arrival by using an application (e.g., navigation application) installed on user device 110 through traffic information system 130 and transmit the estimated time of arrival to cloud network 120.

According to an embodiment of the present disclosure, parking lot reservation unit 240 may identify a (temporary) reservation, a reservation confirmation or a reservation cancellation for a parking lot selected by the user for reservation from among the candidate parking lots. Parking lot reservation unit 240 may receive information indicating one parking lot selected for reservation from user device 110. Parking lot reservation unit 240 may identify a reservation from a vehicle (hereinafter, referred to as “reserved vehicle”) corresponding to user device 110 for the selected parking lot (hereinafter, referred to as “reserved parking lot”). Parking lot reservation unit 240 may check vehicle information (e.g., vehicle license plate number) of the vehicle corresponding to user device 110. For example, parking lot reservation unit 240 may receive vehicle information directly from user device 110 to check the vehicle information. For another example, parking lot reservation unit 240 may check vehicle information corresponding to an identifier of user device 110 (e.g., phone number or identification (ID) number equivalent thereto) or corresponding to information (e.g., joining information) registered in parking lot reservation system 100 by the user. That is, the vehicle information may be previously stored in database 140. Parking lot reservation unit 240 may transmit the vehicle information of the user who wants to reserve the reserved parking lot. Accordingly, the reserved parking lot can recognize that the reserved vehicle has reserved parking space.

In another embodiment, parking lot reservation unit 240 may identify a reservation number corresponding to the user. The reservation number may include an identifier of user device 110 or a randomly generated character sequence. When the reservation is identified, parking lot reservation unit 240 may transmit the reservation number to user device 110 and the reserved parking lot. When entering the reserved parking lot, the user may input the reservation number into a device installed at the entrance to confirm that the reserved vehicle has entered the parking lot.

When the location of the reserved vehicle enters within a reference distance from the reserved parking lot, parking lot reservation unit 240 may confirm or cancel the reservation depending on real-time parking space information of the reserved parking lot. Parking lot reservation unit 240 may regularly check the location of the reserved vehicle. When the location of the reserved vehicle enters within the reference distance from the reserved parking lot, parking lot reservation unit 240 may check real-time parking space information of the reserved parking lot. To this end, parking lot information checking unit 210 may check real-time parking space information when the location of the reserved vehicle enters within the reference distance from the reserved parking lot and provide the real-time parking space information to parking lot reservation unit 240, or may request real-time parking space information from the reserved parking lot and update the real-time parking space information. Parking lot reservation unit 240 may check the real-time parking space information and identify confirmation of the reservation if there is an available parking space. Parking lot reservation unit 240 may transmit a message informing that the reservation has been confirmed to user device 110 and/or the reserved parking lot. Accordingly, since it is estimated that the reserved vehicle will enter the reserved parking lot, one of available parking spaces may be allocated as a parking space for the reserved vehicle. Parking lot reservation unit 240 may check the real-time parking space information and identify cancellation of the reservation if there is no available parking space. When the reservation cancellation is identified, parking lot reservation unit 240 may transmit a message informing that the reservation has been canceled to user device 110 and/or the reserved parking lot. In some embodiments, when the reservation cancellation is identified, parking lot reservation unit 240 may transmit, to user device 110, information about the candidate parking lots other than the reserved parking lot to enable the user to reserve another parking lot.

After the reservation confirmation is identified, parking lot reservation unit 240 may cancel the reservation depending on whether the reserved vehicle enters the reserved parking lot within a reference time. Parking lot reservation unit 240 may determine that the reserved vehicle has not entered the reserved parking lot within the reference time when the reserved parking lot fails to transmit a message informing that the reserved vehicle has entered within the reference time or when parking lot reservation unit 240 checks whether the reserved vehicle has entered the reserved parking lot at the reference time. When the reservation cancellation is identified, parking lot reservation unit 240 may transmit a message informing that the reservation has been canceled to user device 110 and/or the reserved parking lot. Accordingly, it is possible to avoid the occurrence of unforeseen damage to parking lot reservation system 100 caused by not parking in the reserved parking lot even though the user confirms the reservation.

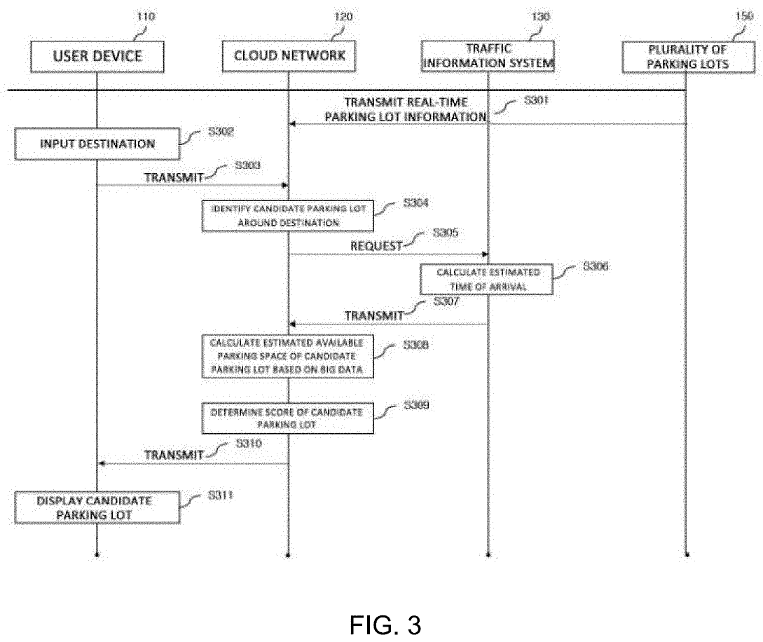

Hereinafter, an operation process performed by parking lot reservation system 100 according to an embodiment of the present disclosure to provide a parking lot recommendation service, an available parking space calculation system, a parking lot reservation and reservation confirmation service and a parking lot reservation notification message service will be described in detail with reference to FIG. 3 to FIG. 10. It is obvious that the following embodiment is just one of various embodiments of the present disclosure, but the present disclosure is not limited thereto.

FIG. 3 illustrate operations of the components included in the parking lot reservation system according to an embodiment of the present disclosure and a process of transmission and reception of data between the components. Referring to FIG. 3, an operation process performed to provide a parking lot recommendation service by the parking lot reservation system according to an embodiment of the present disclosure will be described.

In a process S301, a plurality of parking lots 150 may transmit real-time parking information of each of plurality of parking lots 150 to cloud network 120 (S301). Cloud network 120 may check available parking spaces of a plurality of parking lots by using the received real-time parking lot information.

In a process S302, the user may input a destination through user device 110 in order to search for a parking lot around the destination to go to. For example, the user may execute an application provided by the parking lot reservation system installed on user device 110 and input the destination on the application. In some embodiments, the user may optionally further input an point of departure or an estimated time of departure as well as the destination. However, the point of departure may be determined by detecting the current location of the user (or user device 110), and the estimated time of departure may be determined by the current time.

In a process S303, user device 110 may transmit, to cloud network 120, destination information, point of departure information and an estimated time of departure. In a process S304, cloud network 120 may identify, as candidate parking lots, parking lots located within a reference distance from the destination among plurality of parking lots 150 based on the destination information received from user device 110.

In a process S305, cloud network 120 may transmit the destination information, the point of departure information and the estimated time of departure to traffic information system 130 to request calculation of an estimated time of arrival.

In a process S306, traffic information system 130 may calculate the estimated time of arrival at the destination using the destination information, the point of departure information and the estimated time of departure received from cloud network 120 and traffic condition information. In that case, if the estimated time of departure is not the current time but a specific time input by the user, an estimated time of arrival at the specific time may be calculated using the big data constructed by traffic information system 130.

In a process S307, traffic information system 130 may transmit the calculated estimated time of arrival to cloud network 120. In the above description, it is obvious that a sequence between process S304 and processes S305 to S307 is not limited to that shown in FIG. 3, and these processes may be performed simultaneously or reversely.

In a process S308, cloud network 120 may calculate an estimated available parking space of each of the candidate parking lots based on the estimated time of arrival received from traffic information system 130. In that case, the operation of calculating the estimated available parking space of each of the candidate parking lots may be performed based on the big data. For example, if the estimated time of arrival at the destination is 14:30 on Saturday, the number of estimated available parking spaces may be calculated by analyzing available parking spaces (e.g., calculating an average value) at 14:30 on Saturdays over a period (e.g., 3 months). The method of calculating the number of estimated available parking spaces using big data can be applied in various ways.

In process S305 of another embodiment, cloud network 120 may further transmit information about the candidate parking lots identified in process S304 in addition to the destination information, the point of departure information and the estimated time of departure. In that case, the estimated time of arrival calculated in process S307 may further include an estimated time of arrival from the point of departure to at least one of the candidate parking lots. Accordingly, in S308, when calculating the number of estimated available parking spaces, cloud network 120 may not use big data based on the same estimated time of arrival from the point of departure to the destination but may use big data based on different estimated times of arrival at the respective candidate parking lots, which contributes to a more precise calculation of the number of estimated available parking spaces. In a process S309, cloud network 120 may determine a score of each of the candidate parking lots. The score of each of the candidate parking lots may be determined based on at least one of the estimated available parking spaces, the distance between each candidate parking lot and the destination and the user preference. For example, a candidate parking lot with a large number of estimated available parking spaces may be given a high score because when the user arrives at this candidate parking lot, the parking lot has many spaces so that the user can easily park. Also, the distance between the candidate parking lot and the destination may be too far. In that case, even if the user succeeds in parking, it requires a lot of movement to get to the destination. Therefore, the corresponding parking lot may be given a low score. Further, even when the candidate parking lot has a sufficient number of estimated available parking spaces and is close to the destination, if a parking fee is too expensive, this parking lot may be given a low score for a user who prefers a low price. Furthermore, for a user who does not prefer a tower-type automated parking lot, the tower-type automated parking lot may be given a low score. In some embodiments, the score of each of the candidate parking lots may be determined depending on the estimated available parking spaces, the distance between each candidate parking lot and the destination, the user preference and weightings thereof. For example, if the user places a high importance on the probability of parking, the score is more likely to be determined by the probability of parking than by the distance between the candidate parking lot and the destination and the user preference. The method of determining a score of each candidate parking lot can be applied in various ways.

In a process S310, the candidate parking lots and the scores of the respective candidate parking lots determined by cloud network 120 may be transmitted to user device 110.

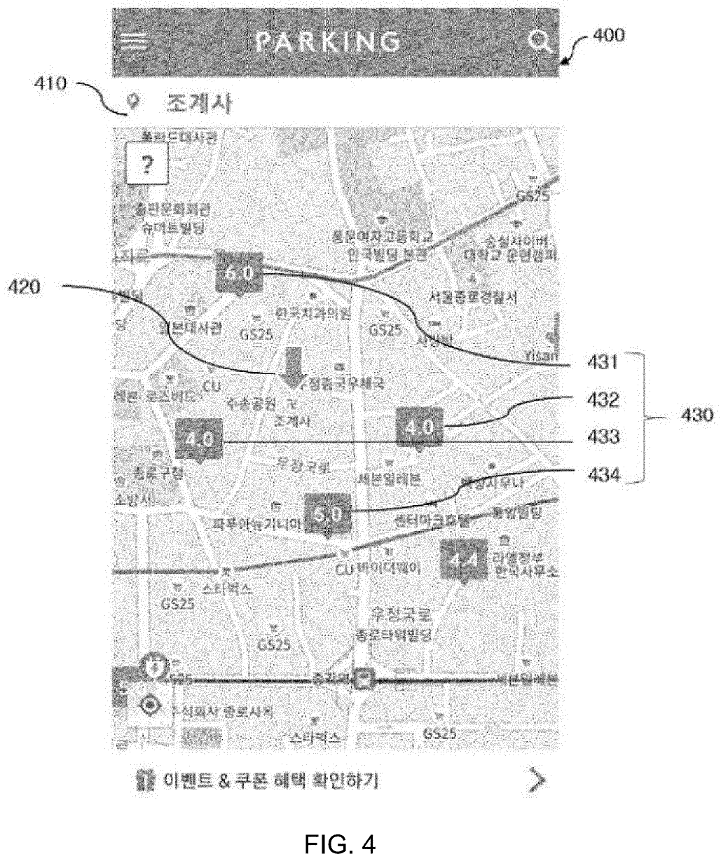

In a process S311, user device 110 may display the received candidate parking lots and scores of the respective candidate parking lots. FIG. 4 shows an example of an application executed on user device 110. Referring to FIG. 4, user device 110 may receive an input of a destination on the application and display an application screen 400 (e.g., GUI) for displaying the candidate parking lots. Application screen 400 may display a search box 410 in which the user can input a destination, an indicator 420 indicating the location of the input destination, and the locations and scores of a plurality of candidate parking lots 430. The user may check application screen 400 and select a parking lot to be reserved from among the candidate parking lots. For example, application screen 400 may display a plurality of parking lots 430 including a first parking lot 431, a second parking lot 432, a third parking lot 433 and a fourth parking lot 434. The user may select (e.g., touch) first parking lot 431 with the highest score of 6.0 from among plurality of parking lots 430 to select first parking lot 431 as a reserved parking lot.

The operation process performed to provide a parking recommendation service by the parking lot reservation system according to an embodiment of the present disclosure has been described above with reference to FIG. 3. In an embodiment of the present disclosure, an operation of calculating an estimated time of arrival at a destination (or parking lot) by using a traffic information system and an operation of calculating estimated available parking spaces at the estimated time of arrival by using big data are further included in addition to an operation of searching for a parking lot around the destination and providing real-time parking lot information of the parking lot around the destination. Thus, it is possible to provide a new service capable of recommending a more reliable candidate parking lot to the user. Also, in an embodiment of the present disclosure, an operation of determining a score of each candidate parking lot based on the distance between the destination and the candidate parking lot and a user preference as well as the estimated available parking spaces is further included. Thus, it is possible to provide a service capable of recommending a more appropriate candidate parking lot to the user.

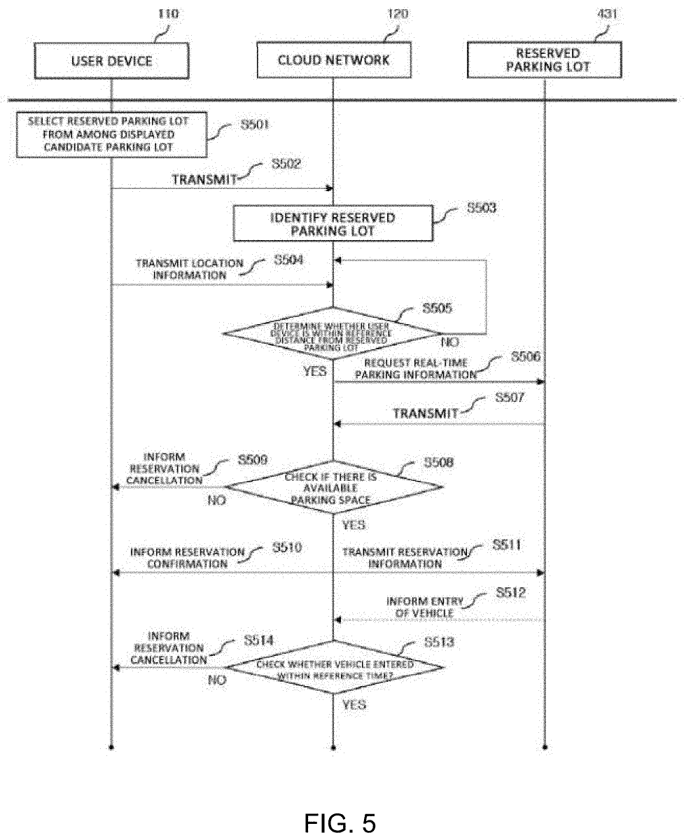

FIG. 5 illustrate operations of the components included in the parking lot reservation system according to an embodiment of the present disclosure and a process of transmission and reception of data between the components. Referring to FIG. 5, an operation process performed to provide a temporary reservation and reservation confirmation service by the parking lot reservation system according to an embodiment of the present disclosure will be described.

In a process S501, user device 110 may receive the user's input to select one parking lot to be reserved from among displayed candidate parking lots. For example, as shown in FIG. 4, the user may select first parking lot 431 as a reserved parking lot from among plurality of candidate parking lots 430 displayed on user device 110.

In a process S502, user device 110 may transmit information about the reserved parking lot to cloud network 120. Accordingly, in a process S503, cloud network 120 may identify reserved parking lot 431.

In a process S504, user device 110 may regularly transmit, to cloud network 120, location information indicating its location. Cloud network 120 may track the location of user device 110 based on the location information transmitted by user device 110.

In a process S505, when cloud network 120 receives the location information of user device 110, cloud network 120 may determine whether the location information is within a reference distance from reserved parking lot 431. When it is determined that the location of user device 110 is not within the reference distance, cloud network 120 may determine again whether location information subsequently transmitted by user device 110 is within the reference distance from reserved parking lot 431.

In a process S506, when it is determined that the location information of user device 110 is within the reference distance from reserved parking lot 431, cloud network 120 may transmit a message requesting real-time parking information to reserved parking lot 431. This is to check available parking spaces of reserved parking lot 431 and check whether the user can actually park the vehicle in reserved parking lot 431 when the user's vehicle approaches reserved parking lot 431.

In a process S507, reserved parking lot 431 may transmit real-time parking information to cloud network 120 in response to the message requesting the real-time parking information transmitted by cloud network 120. In another embodiment, processes S506 and S507 may be replaced with a process in which cloud network 120 checks the real-time parking information of reserved parking lot 431. For example, cloud network 120 may regularly update real-time parking information of a plurality of parking lots including reserved parking lot 431. In that case, cloud network 120 does not need to separately request real-time parking information from reserved parking lot 431.

In a process S508, cloud network 120 may check whether there is an available parking space based on the real-time parking information of reserved parking lot 431. When it is confirmed that there is no available parking space of reserved parking lot 431, the process continues to a process S509 in which cloud network 120 may identify a reservation cancellation for reserved parking lot 431 and transmit, to user device 110, a message informing the reservation cancellation. When it is determined that there is an available parking space of reserved parking lot 431, cloud network 120 may identify a reservation confirmation for reserved parking lot 431, and continues to processes S510 and S511. In process S510, cloud network 120 may transmit, to user device 110, a message informing the reservation confirmation.

In process S511, cloud network 120 may transmit reservation information to reserved parking lot 431. The reservation information may be one of vehicle information, an identifier of user device 110, and a randomly generated reservation number. For example, if the reservation information is vehicle information such as a vehicle license plate number, when vehicle information that matches with the vehicle information as the reservation information is included in recognized vehicle information of incoming vehicles, reserved parking lot 431 may recognize that the reserved vehicle has entered reserved parking lot 431. For another example, if the reservation information is an identifier of user device 110 or a randomly generated reservation number, when the user inputs the reservation number into a device installed at the entrance of reserved parking lot 431 while the reserved vehicle enters reserved parking lot 431, reserved parking lot 431 may recognize that the reserved vehicle has entered reserved parking lot 431.

In a process S512, when the reserved vehicle enters reserved parking lot 431, reserved parking lot 431 may transmit, to cloud network 120, a message informing that the reserved vehicle has entered to notify that the reserved vehicle has entered.

In a process S513, cloud network 120 may check whether the reserved vehicle enters reserved parking lot 431 within a reference time. If a message informing that the reserved vehicle has entered reserved parking lot 431 is transmitted from reserved parking lot 431 within the reference time, cloud network 120 may identify that the reserved vehicle has entered reserved parking lot 431 within the reference time. However, if the message informing that the reserved vehicle has entered reserved parking lot 431 is not transmitted from reserved parking lot 431 within the reference time, the process continues to a process S514 in which cloud network 120 may identify a reservation cancellation for reserved parking lot 431 and transmit, to user device 110, a message informing the reservation cancellation. As described above, the parking lot reservation system of the present disclosure enables a temporary reservation for a parking space and confirmation or cancellation of the reservation depending on the proximity to a parking lot and whether a reserved vehicle actually enters a reserved parking lot within an appropriate time. Thus, while a parking space reservation service is provided to the user, it is possible to minimize damage to the reserved parking lot which may be caused before the reserved vehicle enters the reserved parking lot.

When there is no available parking space in reserved parking lot 431 or when a reservation is canceled because the reserved vehicle does not enter reserved parking lot 431 within a reference time after the reservation is confirmed, the parking lot reservation system according to an embodiment of the present disclosure may further provide a service of recommending an alternative reserved parking lot to the user. For example, in an additional embodiment, when cloud network 120 transmits a message informing a reservation cancellation to user device 110 (e.g., processes S509 and S514), cloud network 120 may further transmit a message guiding the user to an alternative reserved parking lot. In an embodiment, cloud network 120 may transmit a message guiding the user to an alternative reserved parking lot together with a message informing g a reservation cancellation. For example, when the reservation for a first parking lot (431 in FIG. 4) as a reserved parking lot is canceled, cloud network 120 may transmit again a message that enables the user to reserve for another parking lot such as another candidate parking lot (e.g., second parking lot (432 in FIG. 4)). In that case, cloud network 120 may identify real-time available parking space information and estimated parking space information of parking lots except the reserved parking lot and provide it to user device 110.

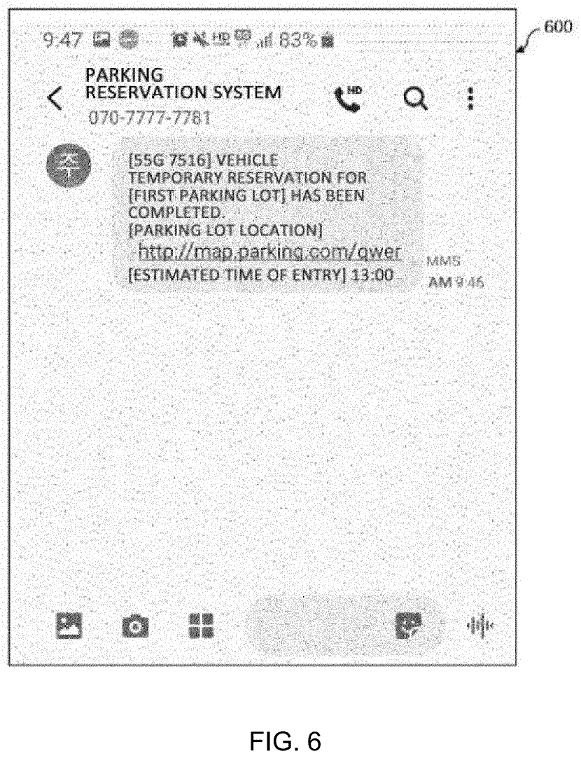

FIG. 6 to FIG. 9 illustrate examples of notification messages for providing information about a parking lot reservation to a user, in accordance with an embodiment of the present disclosure. As described above, parking lot reservation system 100 (or cloud network 120) according to an embodiment of the present disclosure may transmit a message informing the parking lot reservation status to user device 110.

In an embodiment, when cloud network 120 identifies the reserved parking lot as shown in process S503 of FIG. 5, cloud network 120 transmits, to user device 110, a (temporary) reservation message informing that the reservation has been identified. FIG. 6 shows an example 600 in which the (temporary) reservation message transmitted by cloud network 120 is displayed on user device 110.

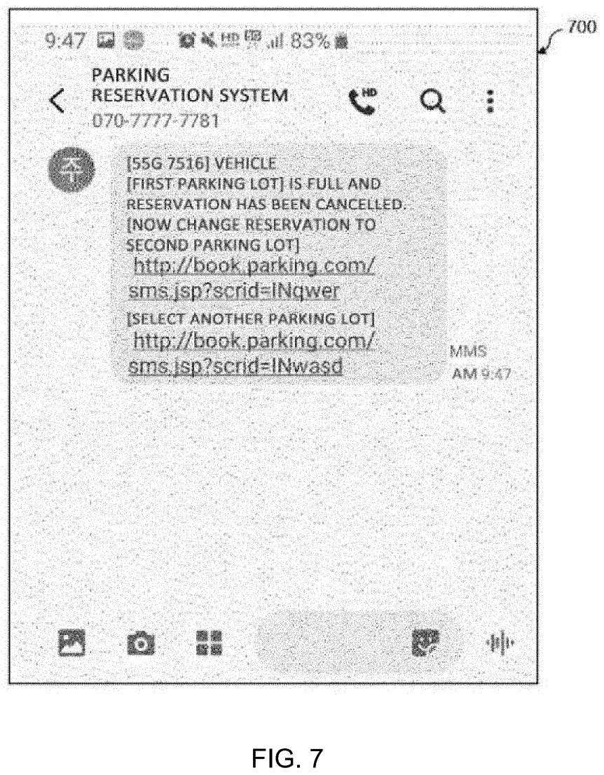

In an embodiment, as shown in process S509 of FIG. 5, cloud network 120 may transmit, to user device 110, a reservation cancellation message informing that the reservation has been canceled as it is confirmed that there is no available parking space in reserved parking lot 431. In another embodiment, in process S509 of FIG. 5, cloud network 120 may transmit, to user device 110, a reservation cancellation message informing that the reservation has been canceled as it is confirmed that there is no available parking space in reserved parking lot 431 and also guiding the user to an alternative reserved parking lot. FIG. 7 shows an example 700 in which the message informing the reservation cancellation and the alternative reserved parking lot transmitted by cloud network 120 is displayed on user device 110.

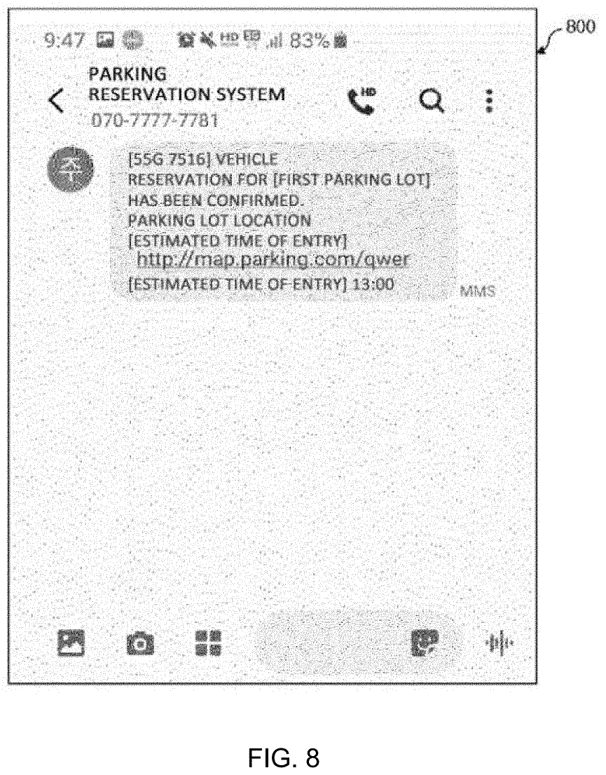

In an embodiment, as shown in process S510 of FIG. 5, cloud network 120 may transmit, to user device 100, a reservation confirmation message informing that the reservation has been confirmed as it is confirmed that there is an available parking space in reserved parking lot 431. FIG. 8 shows an example in which the reservation confirmation message transmitted by cloud network 120 is displayed on user device 110.

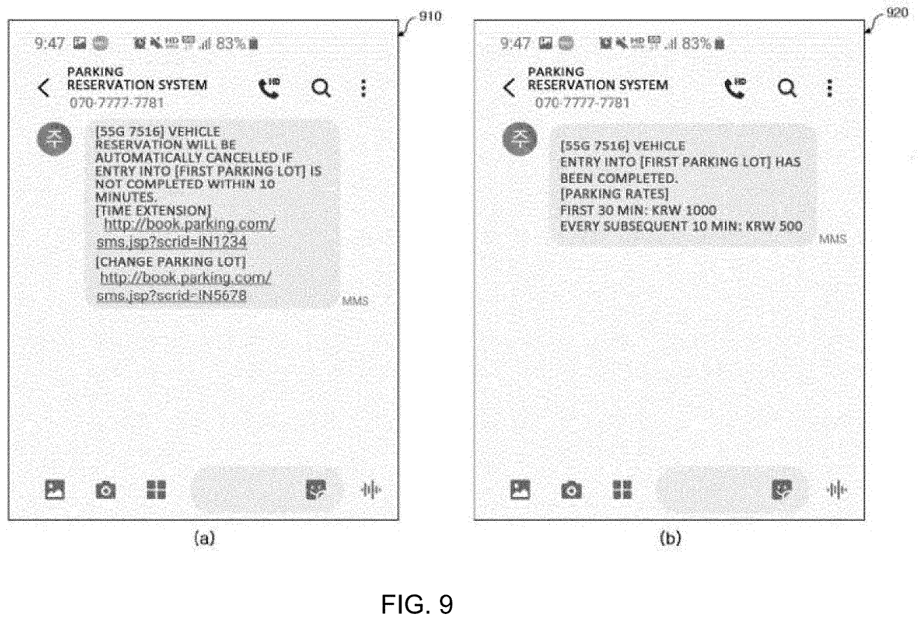

In an embodiment, as shown in process S514 of FIG. 5, when cloud network 120 confirms that the reserved vehicle has not entered the reserved parking lot before the reference time, cloud network 120 may transmit, to user device 110, a reservation cancelation message informing that the reservation has been canceled or is scheduled to be canceled. FIG. 9A shows an example 910 in which the reservation cancellation warning message transmitted by cloud network 120 is displayed on user device 110. Also, in process S512 of FIG. 5, when cloud network 120 receives, from reserved parking lot 431, a message informing that the reserved vehicle has entered reserved parking lot 431, cloud network 120 may transmit an entry completion message to user device 110. FIG. 9B shows an example 920 in which the entry completion message transmitted by cloud network 120 is displayed on user device 110.

The notification messages transmitted by parking lot reservation system 100 (or cloud network 120) according to an embodiment of the present disclosure may be transmitted through a multimedia messaging service (MMS) as shown in FIG. 6 to FIG. 9 described above and may also be transmitted through a short message service (SMS). Although not shown in the drawings, the notification messages may be displayed on user device 110 in the form of a pop-up message or a status bar through an application installed on user device 110. Alternatively, the notification messages may be displayed on user device 110 in the form of a message through a message application such as KakaoTalk or Facebook message. It is obvious that various embodiments which can be implemented by a person with ordinary skill in the art can be applied to display notifications on other user devices 110.

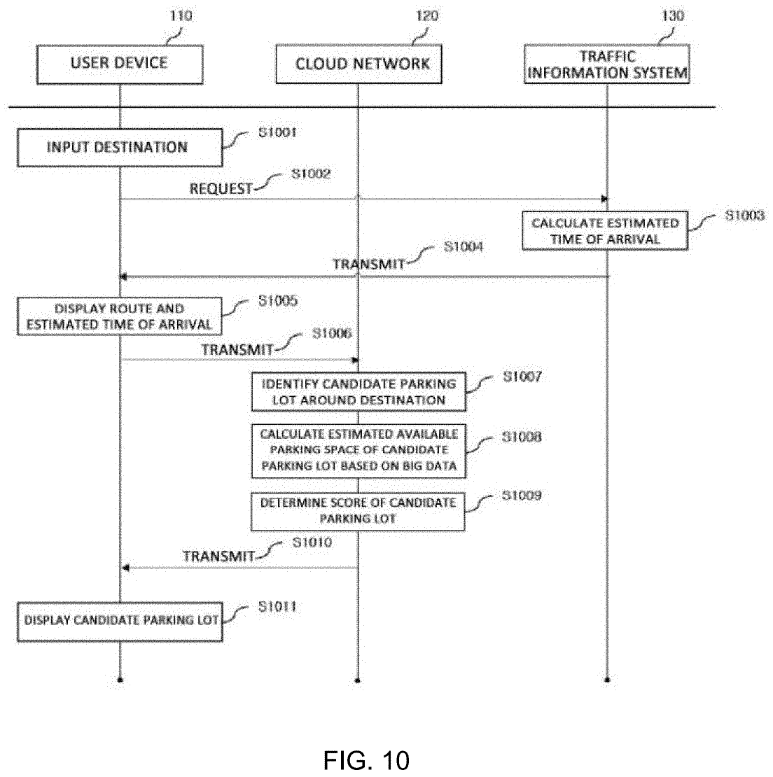

FIG. 10 illustrate operations of components included in a parking lot reservation system according to another embodiment of the present disclosure and a process of transmission and reception of data between the components to provide a parking lot recommendation service. The embodiment described in FIG. 10 is an embodiment in which user device 110 directly calculates an estimated time of arrival by using traffic information system 130, unlike the embodiment described in FIG. 3. A description on the operations explained in FIG. 3 and the operations that can be easily analogized from FIG. 3 will be omitted. In a process S1001, the user may input a destination through user device 110 in order to search for a parking lot around the destination to go to. For example, the user may execute an application provided by the parking lot reservation system installed on user device 110 and input the destination on the application. In some embodiments, the user may optionally further input an point of departure or an estimated time of departure as well as the destination. However, the point of departure may be determined by detecting the current location of the user (or user device 110), and the estimated time of departure may be determined by the current time.

In a process S1002, user device 110 may transmit destination information, point of departure information and an estimated time of departure to traffic information system 130 to request a route and/or calculation of an estimated time of arrival.

In a process S1003, traffic information system 130 may calculate the estimated time of arrival at the destination using the destination information, the point of departure information and the estimated time of departure received from user device 110 and traffic condition information. In that case, if the estimated time of departure is not the current time but a specific time input by the user, an estimated time of arrival at the specific time may be calculated using the big data constructed by traffic information system 130.

In a process S1004, traffic information system 130 may transmit, to user device 110, information about the calculated estimated time of arrival and/or the route.

In a process S1005, user device 110 may provide a directions service (or navigation service) by displaying the information about the estimated time of arrival and/or the route received from traffic information system 130.

In a process S1006, user device 110 may transmit, to cloud network 120, destination information about the input destination, point of departure information and information about the estimated time of arrival. Hereinafter, processes S1007 to S1011 are identical or similar to processes S307 to S311 described in FIG. 3, and, thus, a description thereof will be omitted.

As described above, the embodiments of the present disclosure can be linked to a navigation application that can be executed on user device 110, and since cloud network 120 receives information about an estimated time of arrival directly from user device 110, cloud network 120 can more rapidly identify candidate parking lots and determine scores of the candidate parking lots to provide a more efficient parking lot recommendation service to the user.

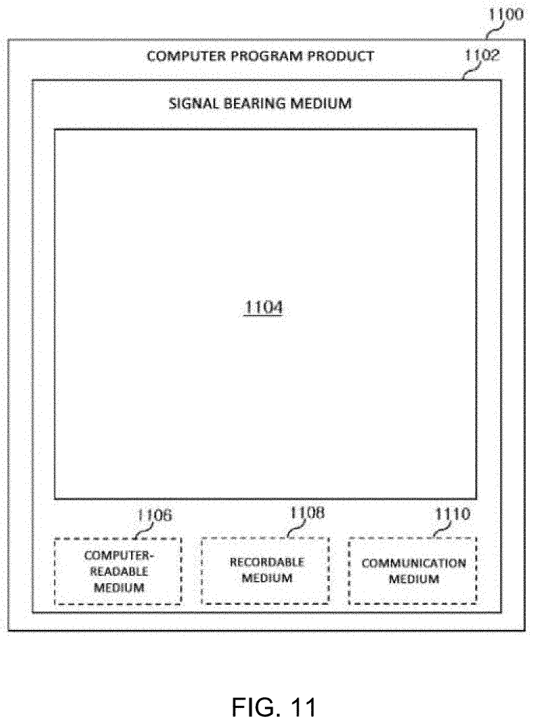

FIG. 11 illustrates an exemplary computer program product 1100 that can be used in entities included in the parking lot reservation system, in accordance at least some embodiments of the present disclosure. Exemplary computer program product 1100 is provided using, for example, a signal-bearing medium 1102. In some embodiments, signal-bearing medium 1102 of one or more computer program products 1100 may include a computer-readable medium 1106, a recordable medium 1108 and/or a communication medium 1110.

Instructions 1104 included in signal bearing medium 1002 may be implemented by computing devices included in, for example, user device 110, cloud network 120, traffic information system 130, database 140 and plurality of parking lots 150, respectively, illustrated in FIG. 1. When executed, instructions 1104 may cause the computing devices to perform operations for providing a parking lot reservation service.

The above description of the present disclosure is provided for the purpose of illustration, and it would be understood by a person with ordinary skill in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner. The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal-bearing medium, a storage medium and/or storage media. This storage media, such as CD-ROMs, computer disks, flash memory, or the like, for example, may have instructions stored thereon, that, when executed by a computing device, such as a computing system, computing platform, or other systems, for example, may result in the execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive. There is little distinction left between hardware and software implementations of aspects of systems; the use of hardware or software is generally a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a main hardware and/or firmware vehicle; if flexibility is paramount, the implementer may opt for a main software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative example of the subject matter described herein applies regardless of the particular type of signal-bearing medium used to carry out the distribution.

While certain example techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

Throughout this document, the term “connected to” may be used to designate a connection or coupling of one element to another element and includes both an element being “directly connected to” another element and an element being “electronically connected to” another element via another element. Through the whole document, the term “on” that is used to designate a position of one element with respect to another element includes both a case that the one element is adjacent to the other element and a case that any other element exists between these two elements. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise. Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A method performed by a computing device included in a system for providing a parking lot reservation service, comprising:
a process of receiving point of departure information and destination information from a user device;
a process of identifying based on the received destination information, real-time parking space information of each of at least one parking lot located within a reference distance from a location of the destination information;
a process of determining at least one candidate parking lot from among the at least one parking lot;
a process of transmitting the point of departure information and the destination information to a traffic information system and receiving an estimated time of arrival which has been calculated by the traffic information system based on the point of departure information and the destination information;
a process of calculating, based on big data stored in a database, an estimated available parking space of each of the at least one candidate parking lot at the estimated time of arrival; and
a process of transmitting, to the user device, information about the at least one candidate parking lot and the estimated available parking space of each candidate parking lot.

2. The method performed by a computing device included in a system of claim 1, further comprising:
a process of calculating a score of the at least one candidate parking lot by using at least one of a distance from the estimated available parking space and the destination to the at least one candidate parking lot, a parking fee of the candidate parking lot, and the candidate parking lot; and
a process of transmitting the calculated score to the user device.

3. The method performed by a computing device included in a system of claim 2, further comprising:
a process of receiving the estimated time of arrival from the user device,
wherein the estimated time of arrival is received in response to a request from the user device to the traffic information system.

4. The method performed by a computing device included in a system of claim 1,
wherein the process of transmitting the point of departure information and the destination information to the traffic information system and receiving the estimated time of arrival which has been calculated by the traffic information system based on the point of departure information and the destination information includes a process of transmitting location information of each of the at least one candidate parking lot to the traffic information system, and
the estimated time of arrival indicates a time of arrival at each of the at least one candidate parking lot.

5. The method performed by a computing device included in a system of claim 1, further comprising:
a process of receiving, from the user device, information about a first parking lot selected by a user from among the at least one candidate parking lot and identifying a reservation from a vehicle associated with the user device for the first parking lot;
a process of checking an available parking space of the first parking lot when it is determined that the vehicle for the user device has entered within a reference distance from a location of the first parking lot; and
a process of identifying a reservation confirmation for the first parking lot when the available parking space of the first parking lot remains as a result of the process of checking the available parking space, and transmitting information about the reservation.

6. The method performed by a computing device included in a system of claim 5, further comprising:
a process of identifying a reservation cancellation for the first parking lot when the available parking space of the first parking lot does not remain as a result of checking the process of checking the available parking space, and transmitting, to the user device, a message informing the reservation cancellation.

7. The method performed by a computing device included in a system of claim 6, further comprising:
a process of checking whether the vehicle has entered the first parking lot before a reference time when the reservation confirmation for the first parking lot is identified; and
a process of identifying a reservation cancellation for the first parking lot when it is identified that the vehicle has not entered the first parking lot within the reference time, and transmitting, to the first parking lot and the user device, a message informing the reservation cancellation.

8. The method performed by a computing device included in a system of claim 6 or claim 7, further comprising:
a process of transmitting, to the user device, information about a second parking lot among the at least one candidate parking lot when the reservation cancellation for the first parking lot is identified.

9. The method performed by a computing device included in a system of claim 1, further comprising:
a process of calculating a score of each of the at least one candidate parking lot based on a user preference stored in the database.

10. The method performed by a computing device included in a system of claim 9,
wherein the user preference includes at least one of a parking fee, a distance from the destination information, whether the parking lot is a tower-type parking lot, whether the parking lot is equipped with an electric vehicle charging device, and a discount component.

11. A computer-readable storage medium that stores a program for providing a parking lot reservation service,
wherein the program includes instructions that, when executed by a computing device, cause the computing device:
to receive point of departure information and destination information from a user device;
to identify, based on the received destination information, real-time parking space information of each of at least one parking lot located within a reference distance from a location of the destination information;
to determine at least one candidate parking lot from among the at least one parking lot;
to transmit the point of departure information and the destination information to a traffic information system and receive an estimated time of arrival which has been calculated by the traffic information system based on the point of departure information and the destination information;
to calculate, based on big data stored in a database, an estimated available parking space of each of the at least one candidate parking lot at the estimated time of arrival; and
to transmit, to the user device, information about the at least one candidate parking lot and the estimated available parking space of each candidate parking lot.
